(19) United States
(12) Patent Application Publication
(10) Pub. No.: US 2025/0115038 A1
(43) Pub. Date: Apr. 10, 2025

(54) IMPREGNATED CELLULOSE FIBRE-BASED SHEET

(71) Applicant: Neenah Gessner GmbH, Bruckmühl (DE)

(72) Inventor: Armin Niederhuber, Bruckmühl (DE)

(21) Appl. No.: 18/910,197

(22) Filed: Oct. 9, 2024

(30) Foreign Application Priority Data
Oct. 10, 2023 (DE) 202023105852.3

(51) Int. Cl. B32B 29/00; B32B 5/18; B65D 65/40

(52) U.S. Cl. CPC B32B 29/007; B32B 5/18; B65D 65/40; B32B 2260/028; B32B 2260/04; B32B 2307/304; B32B 2307/718; B32B 2307/724; B32B 2307/7265; B32B 2307/7376; B32B 2553/00; B65D 2565/388

(57) ABSTRACT

Cellulose fiber-based sheets are provided herein. The sheets are particularly useful for insulation, construction and/or packaging material. A cellulose fiber-based sheet comprises a layer comprising untreated pulp impregnated with cationized vegetable wax. The cellulose fibers can be provided with a cationized vegetable wax thereby modifying the sheet to the extent that a hydrophobic surface is formed. The cationized vegetable wax attaches to the fluffy, fibrous surface of the sheet and seals the surface so that the so-called lotus effect is observed. The material is environmentally friendly, sustainable and imparts water repellence and a water vapour barrier to insulation materials, construction materials, packaging materials and the like.

### CROSS-REFERENCE TO RELATED APPLICATIONS

This application claims the benefit of German Patent Application Serial No. 20 2023 105 852.3, filed Oct. 10, 2023, the complete disclosure of which is incorporated herein by reference for all purposes.

### BACKGROUND

Construction material and packaging material are often required to be water repellent and have a water vapour barrier, respectively. Conventionally, this material is either laminated with, or comprises, a layer of aluminium foil or a layer of a polymeric material such as polyethylene (PE). Another conventional solution is impregnation with a silicone-based material.

These technical solutions, however, are generally not environmentally friendly or sustainable. Thus, it would be desirable to develop and provide a material which is environmentally friendly and sustainable, which imparts water repellence and water vapour barrier, respectively, to construction material, packaging material and related material, and which is producible on industrial scale.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

Cellulose fiber-based sheets are provided herein. The sheets are particularly useful for insulation, construction and/or packaging material.

In one aspect, a cellulose fiber-based sheet comprises a layer comprising untreated pulp impregnated with cationized vegetable wax.

It has been surprisingly discovered that a voluminous sheet comprising cellulose fibers can be provided with a cationized vegetable wax thereby modifying the sheet to the extent that a hydrophobic surface is formed. The cationized vegetable wax surprisingly attached to the fluffy, fibrous surface of the sheet and sealed the surface so that the so-called lotus effect could be observed. The material is environmentally friendly, sustainable and imparts water repellence and a water vapour barrier to insulation materials, construction materials, packaging materials and the like.

In embodiments, the layer has a mass/unit area or grammage of about 30 to about 200 g/m² or at least about 50 g/m² or about 50 to about 150 g/m² as measured according to ISO 536:2019.

In embodiments, the layer has an air permeability of about 100 to about 500 l/m², or about 110 to about 400 l/m², or about 120 to about 300 l/m², or 130 to about 230 l/m² as measured according to EN ISO 9237:1995.

In embodiments, the layer has a water absorption of about 5 to about 30 g/m² or about 10 to about 20 g/m² as measured v ISO 535:2014-06.

In embodiments, the layer has a thickness at 10 kPa of about 0.1 to about 0.8 mm, or about 0.2 to about 0.6 mm as measured according to ISO 534:2012.

In embodiments, the layer comprises pulp selected from the group consisting of wood, fiber crops, rag paper, wastepaper or a combination thereof.

In embodiments, the cationized vegetable wax has a mass per unit area of about 5 to about 20 g/m² or about 7 to about 15 g/m² as measured according to ISO 536:2019.

In embodiments, the cationized vegetable wax comprises a wax having a melting point of about 50 to about 90 degrees Celsius, or about 60 to about 80 degrees Celsius.

In embodiments, the cationized vegetable wax comprises a material selected from the group consisting of soy wax, pea wax, rice wax or a combination thereof. In embodiments, the cationized vegetable wax comprises a cationized solution or emulsion.

In another aspect, an insulation material comprises a foam and a cellulose fiber-based sheet comprising untreated pulp impregnated with cationized vegetable wax.

When used in combination with a foam, which is specified for sound insulation purposes, the instant cellulose fiber-based sheet provides a sustainable, environmentally friendly water barrier layer to the foam.

In embodiments, the untreated pulp has a mass/unit area or grammage of at least about 50 g/m² or about 50 to about 150 g/m² as measured according to ISO 536:2019. In cases wherein the grammage of the untreated pulp is 100 g/m² and higher, the inventors observed that the instant cellulose fibre sheet contributes to the sound insulation of the insulation material comprising a foam.

In another aspect, a packaging material comprises the cellulose fiber-based sheet of any of the embodiments described above.

In embodiments, the layer of cellulose fiber-based sheet has a grammage of about 30 to about 90 g/m² as measured by ISO 536:2019.

In embodiments, the packaging material 18 further comprises an inner liner and an outer liner. The cellulose fiber-based sheet may be disposed between the inner and outer liners.

The instant cellulose fibre-based sheet provides a sustainable, environmentally friendly water barrier layer and replaces conventional aluminium or polymer foils or silicone-based impregnations.

It is to be understood that both the foregoing general description and the following detailed description is exemplary and explanatory only and are not restrictive. Additional features will be set forth in part in the description which follows or may be learned by practice of the description.

### DETAILED DESCRIPTION

This description and the accompanying drawings illustrate exemplary embodiments and should not be taken as limiting, with the claims defining the scope of the description, including equivalents. Various mechanical, compositional, structural, and operational changes may be made without departing from the scope of this description and the claims, including equivalents. In some instances, well-known structures and techniques have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Cellulose fiber-based sheets are provided herein. The sheets are particularly useful for insulation, construction and/or packaging material. The cellulose fiber-based sheets comprise a layer comprising untreated pulp impregnated with cationized vegetable wax.

The layer comprising untreated pulp is a layer comprising pulp that has been treated chemically to remove lignin. In other words, the layer comprises chemical pulp. The pulp of the layer has not been subjected to any other treatment prior to application of the coating with cationised vegetable wax.

The layer comprising untreated pulp may have a grammage of 30 to 200 g/m², preferably 50 to 150 g/m², as measured by ISO 536:2019. In some embodiments the grammage may be 30 to 90 g/m². In some embodiments the grammage may be 90 to 200 g/m² and preferably 100 to 130 g/m².

The layer comprising untreated pulp may have a water absorption of 5 to 30 g/m², preferably 10 to 20 g/m², more preferably 14 to 18 g/m² determined as a COBB 60 and measured according to ISO 535:2014-06.

The layer comprising untreated pulp has a porosity, determined as air permeability, of 100 to 500 l/m² s, preferably 110 to 400 l/m² s, or 120 to 300 l/m² s, or 130 to 230 l/m² as measured according to EN ISO 9237:1995.

The layer comprising untreated pulp may have a thickness of 0.1 to 0.8 mm, preferably 0.2 to 0.6 mm, when under a pressure of 10 kPa and measured according to ISO 534:2012.

The layer may comprise pulp selected from one or more of wood, fiber crops, rag paper or wastepaper.

The impregnation of the layer means the application of a solution or suspension comprising the cationised vegetable wax. The wax penetrates the sheet and is present on the surface of the fibres, so that it is present not only on the surface of the sheet. Depending on the production process and its parameters, the layer comprising the untreated pulp may be fully impregnated with the vegetable wax or only partially impregnated with the wax from one or both sides.

The impregnation of cationised vegetable wax may be comprised on the layer comprising untreated pulp at 5 to 20 g/m², preferably 7 to 15 g/m², more preferably 8 to 12 g/m², as measured according to ISO 536:2019.

The impregnation of cationised vegetable wax may comprise a wax having a melting point of 50 to 90 degrees Celsius, preferably 60 to 80 degrees Celsius. These temperature ranges ensure that during the production process and application of the vegetable wax on the layer comprising untreated pulp the vegetable wax is sufficiently liquid and viscous to be applied to the cellulose fibres of the layer comprising the untreated pulp. At these temperatures, the wax impregnates the layer comprising untreated cellulose fibers, covers the cellulose fibres and is also dried.

The impregnation of cationised vegetable wax may comprise cationised soy wax, pea wax, rice bran wax, sugar bran wax, palm wax or a mixture thereof, wherein the wax has been cationised by procedures known in the art of fatty acid derivation and modification. Preferably, a cationised soy wax sold by Eurikas under the name EurikaCoat SW144 may be used.

The impregnation of cationised vegetable wax may comprise a cationised solution or emulsion of cationised soy wax, pea wax or rice wax or a mixture thereof, wherein cationization is achieved by standard cationic emulgators.

The use of a cationised vegetable wax achieves adhesion of the vegetable wax on the cellulose fibres of the layer comprising the untreated pulp. Due to the wax, the layer comprising the untreated pulp becomes hydrophobic, so that when drops of water had been applied on the surface of the cellulose fibre-based sheet of the instant disclosure, the lotus effect was still observable after twelve hours (overnight). Therefore, the instant disclosure provides a cellulose fibre-based sheet which is a sustainable, environmentally friendly water barrier layer.

The cellulose fibre-based sheet is applicable in various technical fields such as for sound insulation. If the cellulose fibre-based sheet comprises a layer of untreated pulp having a high grammage and high porosity, determined as air permeability, the sheet of the instant disclosure may provide some sound insulation as well as protection from moisture when applied in walls, roofs, ceilings or floorings. It may also be applied in door panels or other parts of chassis of vehicles.

In an example, an insulation material comprises a foam and the cellulose fibre-based sheet described above, wherein the layer comprising untreated pulp has a grammage of at least 50 g/m² as measured by ISO 536:2019.

The grammage may be 90 to 200 g/m², preferably 100 to 130 g/m². The porosity, measured as air permeability, of the insulation material may be 120 to 500 l/m²·s according to EN ISO 9237:1995.

The foam may be a standard foam commonly used in the field of construction materials for housing to achieve sound insulation, in particular footfall sound insulation. When applying the sheet to the foam, it has been observed that the sound insulation properties of the composite product are improved. Therefore, the sheet at high grammage provides hydrophobic and sound insulation properties, while being sustainable and environmentally friendly.

The cellulose fibre-based sheet is also applicable as a packing material. Due to the water vapour barrier provided by the wax coating on the sheet, it is useful to pack devices which are moisture-sensitive or food.

In an example, a food packaging material comprises the cellulose fibre described above, wherein the layer comprising untreated pulp has a grammage of 30 to 90 g/m² as measured by ISO 536:2019.

The sheet replaces conventional aluminium foils, polymeric sheets, or cellulose fibre-based sheet which have been laminated with polymeric sheets to attain a water barrier.

The sheet is also useful as part of corrugated construction material, wherein the sheet described above may be comprised as inside or outside liner.

The cellulose fibre-based sheet may be produced by various processes well known in the paper-producing and processing industry. A cellulose fibre-based sheet as described above having a high grammage, such as 90 to 200 g/m², preferably 100 to 130 g/m² and high porosity, such as 120 to 500 l/m² s, may be produced on an inclined wire machine, whereby the layer comprising untreated pulp is formed which is then fed into a size press to achieve application of the coating of the vegetable wax and impregnation with the vegetable wax as described above. The extent of impregnation of the cellulose fibre-based sheet by the vegetable wax may be adjusted by settings of the size press. As a result, the sheet is impregnated, respectively, from both sides.

A cellulose fibre-based sheet as described above having lower grammage, i.e., a thinner paper, may be produced by standard wet laid processes. The paper may then be impregnated or coated by a coater from one side or both sides.

Other embodiments will be apparent to those skilled in the art from consideration of the specification and practice of the embodiment disclosed herein. It is intended that the specification and examples be considered as exemplary only, with a true scope and spirit of the embodiment being indicated by the following claims.

What is claimed is:

1. A cellulose fiber-based sheet comprising:
a layer comprising untreated pulp; and
wherein the layer is impregnated with cationized vegetable wax.

2. The cellulose fiber-based sheet of claim 1, wherein the layer has a mass/unit area of about 30 to about 200 g/m².

3. The cellulose fiber-based sheet of claim 1, wherein the layer has a mass/unit area of about 50 to about 150 g/m².

4. The cellulose fiber-based sheet of claim 1, wherein the layer has an air permeability of about 100 to about 500 l/m².

5. The cellulose fiber-based sheet of claim 1, wherein the layer has an air permeability of about 130 to about 230 l/m².

6. The cellulose fiber-based sheet of claim 1, wherein the layer has a water absorption of about 5 to about 30 g/m².

7. The cellulose fiber-based sheet of claim 1, wherein the layer has a water absorption of about 10 to about 20 g/m².

8. The cellulose fiber-based sheet of claim 1, wherein the layer has a thickness at 10 kPa of about 0.1 to about 0.8 mm.

9. The cellulose fiber-based sheet of claim 1, wherein the layer has a thickness at 10 kPa of about 0.2 to about 0.6 mm.

10. The cellulose fiber-based sheet of claim 1, wherein the layer comprises pulp selected from the group consisting of wood, fiber crops, rag paper, wastepaper or a combination thereof.

11. The cellulose fiber-based sheet of claim 1, wherein the cationized vegetable wax has a mass per unit area of about 5 to about 20 g/m².

12. The cellulose fiber-based sheet of claim 1, wherein the cationized vegetable wax has a mass per unit area of about 7 to about 15 g/m².

13. The cellulose fiber-based sheet of claim 1, wherein the cationized vegetable wax comprises a wax having a melting point of about 50 to about 90 degrees Celsius.

14. The cellulose fiber-based sheet of claim 1, wherein the cationized vegetable wax comprises a material selected from the group consisting of soy wax, pea wax, rice wax or a combination thereof.

15. The cellulose fiber-based sheet of claim 14, wherein the cationized vegetable wax comprises a cationized solution or emulsion.

16. An insulation material comprising:
a foam; and
a cellulose fiber-based sheet comprising untreated pulp impregnated with cationized vegetable wax.

17. The insulation material of claim 16, wherein the untreated pulp has a mass/unit area of at least about 50 g/m².

18. A packaging material comprising the cellulose fiber-based sheet of claim 1.

19. The packaging material of claim 18 further comprising:
an inner liner; and
an outer liner.

20. The packaging material of claim 19, wherein the cellulose fiber-based sheet is disposed between the inner and outer liners.
